(19) United States
(12) Patent Application Publication
(10) Pub. No.: US 2022/0318615 A1
(43) Pub. Date: Oct. 6, 2022

(54) TIME-ALIGNED RECONSTRUCTION RECURRENT NEURAL NETWORK FOR MULTI-VARIATE TIME-SERIES

(71) Applicant: INTERNATIONAL BUSINESS MACHINES CORPORATION, Armonk, NY (US)

(72) Inventors: Toshiya Iwamori, Tokyo (JP); Akira Koseki, Yokohama-shi (JP); Hiroki Yanagisawa, Tokyo (JP); Takayuki Katsuki, Tokyo (JP)

(21) Appl. No.: 17/223,183

(22) Filed: Apr. 6, 2021

(51) Int. Cl. G06N 3/08; G06N 3/04

(52) U.S. Cl. CPC G06N 3/08; G06N 3/0445; G06N 3/0454

(57) ABSTRACT

A computer-implemented method for reconstructing time series data including irregular time intervals and missing values to predict future data from the time series data using a Recurrent Neural Network (RNN) is provided including obtaining irregular time series data X={x₁, . . . , xₜ, . . . , x_{T}} and time interval data Δ={δ₁, . . . , δₜ, . . . , δ_{T}}, where xₜ is a D-dimensional feature vector, T is a total number of observations, δₜ is a D-dimensional time interval vector, and a d-th element δₜ^{d} of δₜ represents a time interval from a last observation, replacing missing values in xₜ with imputed values using an imputation to obtain \tilde{x}ₜ, rescaling data of the time interval δₜ to obtain rescaled time interval data φ(δₜ) by calculating φ(δₜ)= [symbol] _{φ} log(e+ max(0, [symbol] ϕδₜ+b_{ϕ}))+b_{φ}, where W_{φ}, W_{ϕ}, b_{ϕ}, b_{φ} are network parameters of a neural network and e is Napier's constant, and multiplying \tilde{x}ₜ by φ(δₜ) to obtain \hat{x}t as regular time series data for input of the RNN.

### BACKGROUND

The present invention relates generally to learning patterns from time series data, and more specifically, to a time-aligned reconstruction recurrent neural network for multi-variate times series data.

Multivariate time series data (MTS) are ubiquitous in real-world applications. Recurrent neural networks (RNNs) are effective for learning patterns from sequential data such as MTS. However, irregular time intervals and missing values are very common in MTS, making it difficult to apply RNNs in MTS forecasting. Existing RNN methods are effective for addressing missing values but not irregular time intervals.

### SUMMARY

In accordance with an embodiment, a computer-implemented method for reconstructing time series data including irregular time intervals and missing values to predict future data via a time-aligned reconstruction recurrent neural network (TR-RNN) architecture is provided. The computer-implemented method includes obtaining irregular time series data X={x₁, . . . , xₜ, . . . , x_{T}} and time interval data Δ={δ₁, . . . , δₜ, . . . , δ_{T}}, where xₜ is a D-dimensional feature vector, T is a total number of observations, δₜ is a D-dimensional time interval vector, and a d-th element δₜ^{d} of δₜ represents a time interval from a last observation, replacing missing values in xₜ with imputed values using an imputation to obtain \tilde{x}ₜ, rescaling data of the time interval δₜ to obtain rescaled time interval data φ(δₜ) by calculating φ(δₜ)= [symbol] _{ϕ} log(e+ max(0, [symbol] _{ϕ}δₜ+b_{ϕ}))+b_{ϕ}, where W_{φ}, W_{ϕ}, b_{ϕ},b_{φ} are network parameters of a neural network and e is Napier's constant, and multiplying \tilde{x}ₜ by φ(δₜ) to obtain \hat{x}t as regular time series data for input to the TR-RNN architecture.

In accordance with another embodiment, a computer program product for reconstructing time series data including irregular time intervals and missing values to predict future data via a time-aligned reconstruction recurrent neural network (TR-RNN) architecture is provided. The computer program product includes a computer readable storage medium having program instructions embodied therewith, the program instructions executable by a computer to cause the computer to obtain irregular time series data X={x₁, . . . , xₜ, . . . , x_{T}} and time interval data Δ={δ₁, . . . , δₜ, . . . , δ_{T}}, where xₜ is a D-dimensional feature vector, T is a total number of observations, δₜ is a D-dimensional time interval vector, and a d-th element δₜ^{d} of δₜ represents a time interval from a last observation, replace missing values in xₜ with imputed values using an imputation to obtain \tilde{x}ₜ, rescale data of the time interval δₜ to obtain rescaled time interval data φ(δₜ) by calculating φ(δₜ)= [symbol] _{φ} log (e+ max(0, [symbol] _{φ}, δₜ+b_{ϕ}))+b_{φ}, where W_{φ}, W_{ϕ}, b_{φ}, b_{ϕ}, are network parameters of a neural network and e is Napier's constant, and multiply \tilde{x}^{t} by φ(δₜ) to obtain \hat{x}ₜ as regular time series data for input to the TR-RNN architecture.

In accordance with yet another embodiment, a computer-implemented method for reconstructing time series data including irregular time intervals and missing values to predict future data via a time-aligned reconstruction recurrent neural network (TR-RNN) architecture is provided. The computer-implemented method includes performing imputation by using a weighted mean of a value of a last observation and an empirical mean, transforming, via time-aligned reconstruction, inputs to time-aligned representations incorporating time intervals to handle the irregular time intervals as regular time intervals, and employing a recurrent layer.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The invention will provide details in the following description of preferred embodiments with reference to the following figures wherein:

FIG. 1 shows an exemplary time-aligned reconstruction recurrent neural network (TR-RNN), in accordance with an embodiment of the present invention;

FIG. 2 is an exemplary TR-RNN vs. conventional recurrent neural network (RNN), in accordance with an embodiment of the present invention;

FIG. 3 is a block/flow diagram of an exemplary method for applying TR-RNN to multivariate time series data, in accordance with an embodiment of the present invention;

FIG. 4 is an exemplary equation for time-aligned reconstruction, in accordance with an embodiment of the present invention;

FIG. 5 is an exemplary neuromorphic and synaptronic network including a crossbar of electronic synapses interconnecting electronic neurons and axons, in accordance with an embodiment of the present invention;

FIG. 6 is a block/flow diagram of an exemplary processing system employing the TR-RNN via an artificial intelligence (AI) accelerator chip, in accordance with an embodiment of the present invention;

FIG. 7 is a block/flow diagram of an exemplary cloud computing environment, in accordance with an embodiment of the present invention;

FIG. 8 is a schematic diagram of exemplary abstraction model layers, in accordance with an embodiment of the present invention;

FIG. 9 illustrates practical applications for employing the TR-RNN via an AI accelerator chip, in accordance with an embodiment of the present invention;

FIG. 10 is a block/flow diagram of a method for employing the TR-RNN with Internet of Things (IoT) systems/devices/infrastructure, in accordance with an embodiment of the present invention; and

FIG. 11 is a block/flow diagram of exemplary IoT sensors used to collect data/information related to the TR-RNN operations, in accordance with an embodiment of the present invention.

Throughout the drawings, same or similar reference numerals represent the same or similar elements.

### DETAILED DESCRIPTION

Embodiments in accordance with the present invention provide methods and devices for employing a time-aligned reconstruction recurrent neural network for multi-variate times series data. Multivariate time series data (MTS) can be seen in many real-world applications, including finance, healthcare, and traffic analysis. Recurrent neural networks (RNNs) are useful for learning patterns from sequential data such as MTS. However, applying RNNs to MTS is challenging because irregular time intervals are common in MTS data, such as, e.g., electronic health records (EHRs). In particular, the time interval between visits such as for lab results and medications varies from patient to patient depending on the condition of their health. Furthermore, missing values are very common in MTS and not all variables are always observed. The variables that are not observed become missing values.

The exemplary embodiments refer to time series data with uniform time intervals as a regular time series and refer to time series data with irregular time intervals and missing values as an irregular time series. The exemplary embodiments present a time-aligned reconstruction recurrent neural network (TR-RNN), an RNN architecture, to handle irregular time intervals and missing values. The TR-RNN first imputes missing values employing a method which uses the weighted mean with the empirical mean and the last observation based on time intervals. Then, the TR-RNN reconstructs inputs to the uniformly time-aligned representations, incorporating time intervals to treat irregular time series data as regular time series data. Since the input data are aware of irregular time intervals in the TR-RNN, the RNN does not need to take irregular time intervals into account.

The exemplary embodiments further introduce time-aligned reconstruction for transforming inputs to time-aligned representations that incorporate time intervals to treat or handle irregular time series data as regular time series data. The exemplary method can be applied to any variants of CNNs and RNNs because of uniform time alignment.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

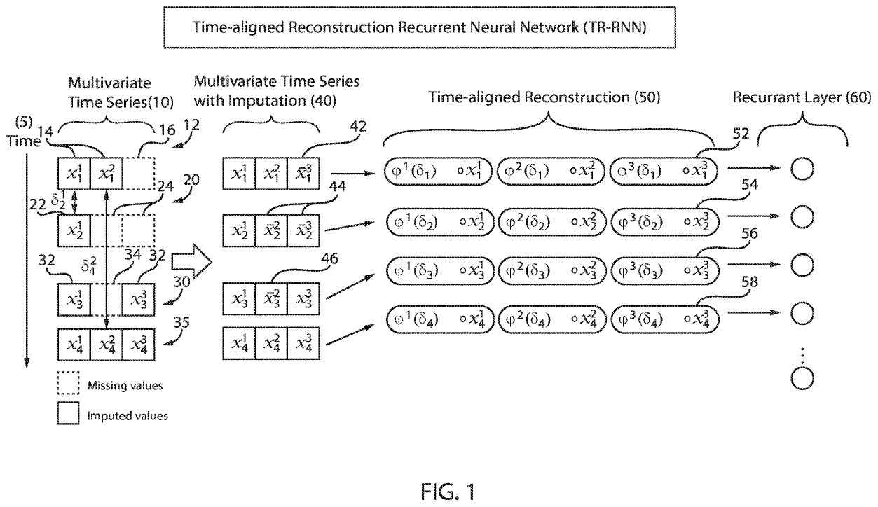

FIG. 1 shows an exemplary time-aligned reconstruction recurrent neural network (TR-RNN), in accordance with an embodiment of the present invention.

The TR-RNN, a variant of RNNs, handles irregular time intervals and missing values. The TR-RNN includes several components. The first component is imputation using a weighted mean of the value at the last observation and empirical mean. The second component is time-aligned reconstruction, which transforms inputs to time-aligned representations incorporating time intervals to treat irregular time series data as regular time intervals. Since inputs in the TR-RNN are aware of irregular time intervals, the RNN does not need to consider irregular time intervals. The third component is the recurrent layer. The exemplary TR-RNN architecture can be applied to any variant of RNNs, including at least long short-term memory (LSTM), gated recurrent units (GRU).

The TR-RNN can use an imputation method to handle missing values. For example, GRU-D which is a variant of GRU uses decay to impute values close to the empirical mean over time instead of using the last observation as is.

The missing value x̅ₜ^{d} is imputed as follows:

x̅ₜ^{d}=γₜ^{d}\ddot{x}ₜ^{d}+(1−γₜ^{d})\dot{x}ₜ^{d}

γₓ_{ₜ}=exp(−max(0,W_{γx}δₜ=b_{γ}_{ₓ}))

where \ddot{x}ₜ^{d} is the last observation of the d-th variable which is the closest variable before the time step t−1 and \dot{x}ₜ^{d} is the empirical mean of the d-th variable, W_{γ}_{ₓ} ∈ [symbol] ^{DxD} and b_{γ}_{ₓ} ∈ [symbol] ^{D} are the network parameters.

Some methods can be employed to impute missing values. We use the standard method, GRU-D, in which only missing values are replaced.

$${\tilde{x}}_{t}^{d} = \{ \begin{matrix}{x}_{t}^{d} {m}_{t}^{d} = 1 \\ {\tilde{x}}_{t}^{d} {m}_{t}^{d} = 0\end{matrix}$$

Time-aligned reconstruction replaces inputs with time-aligned representations, incorporating time intervals to treat or handle irregular time series data as regular time series data. The models do not need to consider irregular time intervals because inputs are aware of the irregular time intervals. In time-aligned reconstruction, the time interval of each input is first rescaled with scale parameters, such as, W_{φ}, W_{δ}, and a log transformation. Then the rescaled time intervals are multiplied to inputs xₜ to maintain their relative positions.

Time-aligned reconstruction is defined as follows:

\hat{x}ₜ=φ(δₜ)∘\tilde{x}ₜ

φ(δₜ)= [symbol] _{φ}log (e+max(0, [symbol] _{ϕ}δₜ+b_{ϕ}))+b_{φ}

where \tilde{x}ₜ is the input of observations xₜ ∈R^{D} or input of imputation x̅ₜ ∈ [symbol] ^{D}. The operator ∘ is the element-wise product, and δₜ ∈ [symbol] ^{D} is a time interval vector, W_{φ}, Wδ, ∈^{DxD} and b_{φ}∈ [symbol] ^{D} are the network parameters and e is the Napier's constant.

Algorithm 1, reproduced below, shows the detailed TR-RNN algorithm. Note that exponential decay is not employed. Instead the exemplary methods multiply rescaled time intervals to inputs, as shown in Table 1 below.

Algorithm 1 Time-aligned reconstruction with
recurrent neural network.

```
Input: input variables and their time intervals
{(xₜ, δₜ)}_{t=1...T}
  1: Let h₀ = 0
  2: for t in 1, 2, . . . , T do
  3: \hat{x}ₜ = Linear (log (e + max(0,Linear(δₜ)))) ∘ xₜ
  4: hₜ = RNNCell(\hat{x}ₜ, hₜ₋₁)
  5: end for
  6: Return {hₜ}_{t=1...T}
```

The decay mechanism is designed so that the decayed value is limited in the range between 0 and 1. Therefore, if exponential decay is used, the space represented by combination inputs xₜ and transformed time intervals is limited. It cannot sufficiently represent relationships between inputs and time intervals.

| Method | Time-aware mechanisim |
|---|---|
| RNN-decay | e^{-max(0, W}^{_{γh}}^{δ}^{ₜ}⁾ ○ hₜ |
| GRU-D | e^{-max(0, W}^{_{γh}}^{δ}^{ₜ}⁾ ○ hₜ |
| TR-RNN | W_{φ} log (e + max(0, W_{δ}δₜ)) ○ xₜ |

As discussed above, patients are periodically tested to monitor their conditions. If the patients maintain good health, the time intervals between their visits are long. The longer the interval is, the lower the patient's risk of a severe health condition or mortality. Since the value using exponential decay is close to zero over time, such value does not affect outputs. However, the exemplary transformation employed by the embodiments of the present invention can affect the model to identify patients' that are at a low risk because the exemplary method can multiply the value over 1 to inputs.

FIG. 1 illustrates multivariate times series 10 received over time 5. The first string of data 12 includes values 14 and missing value 16. The second string of data 20 includes value 22 and missing values 24. The third string of data 30 includes values 32 and missing value 34. The fourth string of data 35 includes all values. The missing values are then filled in with imputation 40. The first missing value is filled with imputed value 42 at first data string 12. Second missing values are filled with imputed values 44 at the second data string 20. A third missing value is filled with imputed value 46 at the third data string 30. The strings of data including the imputed values are passed through time-aligned reconstruction 50, where equations 52, 54, 56, 58 are applied to respective strings 12, 20, 30, 25. Recurrent layers 60 are then obtained.

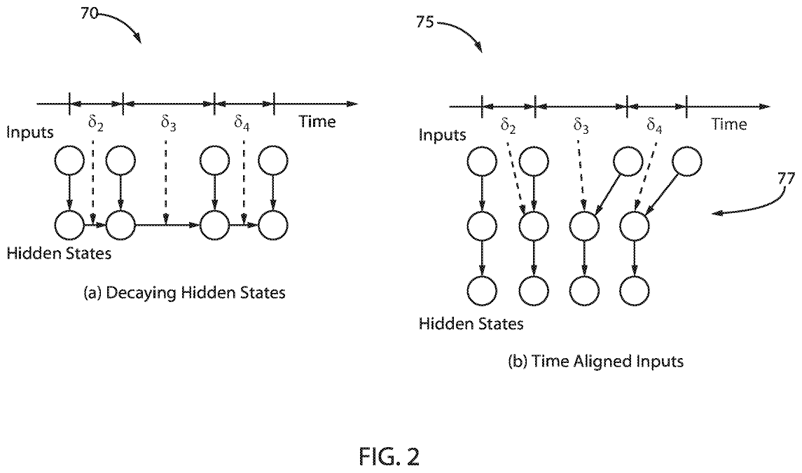

FIG. 2 is an exemplary TR-RNN vs. conventional recurrent neural network (RNN), in accordance with an embodiment of the present invention.

Previous studies proposed applying exponential decay to hidden states based on elapsed time to adjust irregular time intervals. GRU-D imputes missing values with the weighted mean of the previous input values and the overall mean. The weight is computed from the time interval. However, using exponential decay was empirically demonstrated to be ineffective for predictive performance. It is hypothesized that this is because decaying hidden states handle irregular time intervals, as shown in structure 70 of FIG. 2. The decay mechanism is designed such that hidden states are decayed over time. However, this makes it difficult to sufficiently capture effects of time intervals. For example in clinical settings, if patients maintain good health, time intervals between their visits can be long. In such cases, long time intervals indicate the patients are at low risk of the severe condition or mortality. Thus, long time intervals should be incorporated into hidden states to increase the values which affect RNNs to identify patients at low risk. However, the existing methods cannot increase the values of hidden states.

Furthermore, even though hidden states are decayed based on time intervals, hidden states cannot be adjusted with respect to the relationships between each input and its interval because hidden states which are represented with linear combinations of inputs are not directly related to each input. Therefore, transformation of inputs, not hidden states, may be more desirable to handle irregular time intervals.

The exemplary methods propose a time-aligned reconstruction recurrent neural network (TR-RNN), an RNN architecture, to handle irregular time intervals and missing values. The TR-RNN first imputes missing values employing a method, which uses the weighted mean with the empirical mean and the last observation based on time intervals. Then, the TR-RNN reconstructs inputs to the uniformly time-aligned representations, incorporating time intervals 77 to treat or handle irregular time series data as regular time series data, as shown in structure 75 of FIG. 2. Since the input data are aware of irregular time intervals in the TR-RNN, the RNN does not need to take irregular time intervals into account.

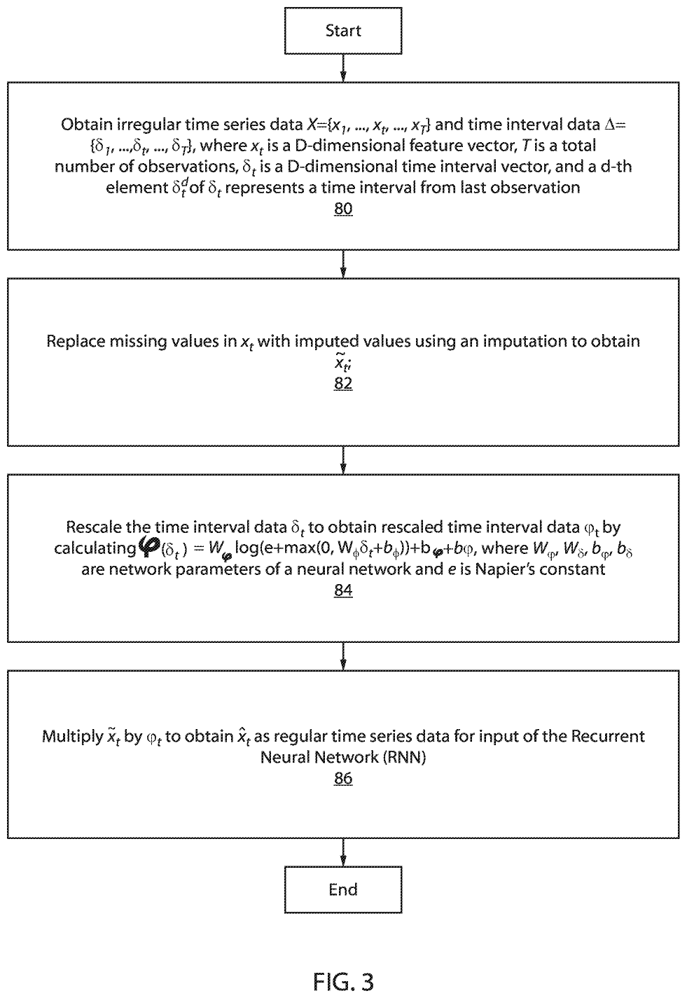

FIG. 3 is a block/flow diagram of an exemplary method for applying TR-RNN to multivariate time series data, in accordance with an embodiment of the present invention.

At block 80, obtain irregular time series data X={x₁, . . . , xₜ, . . . , x_{T}} and time interval data Δ={δ₁, . . . , δₜ, . . . , δ_{T}}, where xₜ is a D-dimensional feature vector, T is a total number of observations, δₜ is a D-dimensional time interval vector, and a d-th element δₜ^{d} of δₜ represents a time interval from last observation.

At block 82, replace missing values in xₜ with imputed values using an imputation to obtain \tilde{X}ₜ.

At block 84, rescale the time interval data δₜ to obtain rescaled time interval data φₜ by calculating φ(δₜ)= [symbol] _{φ} log(e+ max(0, [symbol] _{ϕ}δₜ+b_{ϕ}))+b_{ϕ}, where W_{φ}, W_{ϕ}, b_{φ}, b_{ϕ} are network parameters of a neural network and e is Napier's constant.

At block 86, multiply \tilde{X}ₜ by φ(δₜ) to obtain \hat{X}ₜ as regular time series data for input of the Recurrent Neural Network (RNN).

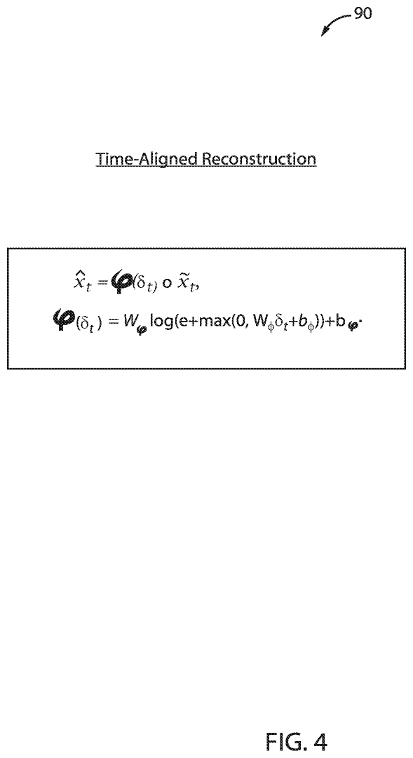

FIG. 4 is an exemplary equation 90 for time-aligned reconstruction, in accordance with an embodiment of the present invention.

The time-aligned reconstruction is given as:

\hat{X}ₜ=φ(δₜ)∘\tilde{x}ₜ

φ(δₜ)= [symbol] _{φ}log (e+max(0, [symbol] _{ϕ}δₜ+b_{ϕ}))+b_{φ}

In conclusion, the exemplary methods introduce a TR-RNN architecture to handle the irregular time intervals and missing values. First, TR-RNN imputes missing values using a weighted mean with the empirical mean and the last observation on the basis of the time interval. Then, the TR-RNN transforms inputs into a time-aligned representation which incorporates time intervals to treat irregular time series data as regular time series data.

In another embodiment, the exemplary method can be applied to any variants of RNNs including at least long short-term memory (LSTM) and gated recurrent units (GRU). In the instant case, the exemplary methods use the RNN.

The current hidden state is updated as follows:

hₜ=RNNCell(\hat{x}ₜ,hₜ₋₁)

where hₜ₋₁, hₜ are previous and current hidden states, and W ∈ [symbol] ^{HxD}, U∈ [symbol] ^{HxH}, and b ∈ [symbol] ^{H} are the network parameters, where H is the number of units of the hidden nodes.

Regarding the objective function, in the final prediction model, the true label γ is predicted as follows:

\hat{γ}=σ(Wₚhₜ+bₚ)

where hₜ is the current hidden state and Wₚ∈ [symbol] ^{1xH} and bₚ ∈ [symbol] are network parameters.

In a multi-classification, cross entropy is used as the objective function shown below:

$$l ( {y}^{⌢} , y ) = {\sum }_{l = 1}^{N} {\sum }_{i = 1}^{M} ( {y}_{\{ li \}} ln {{y}^{⌢}}_{\{ li \}} )$$

where M is a number of classes, γ\hat{ }{li} and γ{li} are the value of the predicted value for each class i and the true label for each class i of the l-th sample of a mini-batch, respectively, and Nis a mini-batch-size.

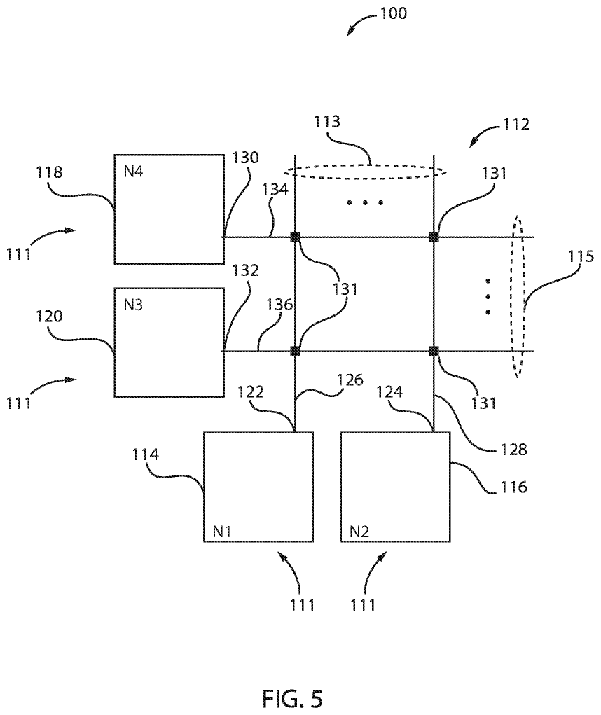

FIG. 5 is an exemplary neuromorphic and synaptronic network including a crossbar of electronic synapses interconnecting electronic neurons and axons, in accordance with an embodiment of the present invention. The neuromorphic and synaptronic network can implement the TR-RNN of the exemplary embodiments of the present invention.

The example tile circuit 100 has a crossbar 112 in accordance with an embodiment of the invention. In one example, the overall circuit can include an “ultra-dense crossbar array” that can have a pitch in the range of about 10 nm to 500 nm. However, one skilled in the art can contemplate smaller and larger pitches as well. The neuromorphic and synaptronic circuit 100 includes the crossbar 112 interconnecting a plurality of digital neurons 111 including neurons 114, 116, 118 and 120. These neurons 111 are also referred to herein as “electronic neurons.” For illustration purposes, the example circuit 100 provides symmetric connections between the two pairs of neurons (e.g., N1 and N3). However, embodiments of the invention are not only useful with such symmetric connection of neurons, but also useful with asymmetric connection of neurons (neurons N1 and N3 need not be connected with the same connection). The cross-bar in a tile accommodates the appropriate ratio of synapses to neurons, and, hence, need not be square.

In the example circuit 100, the neurons 111 are connected to the crossbar 112 via dendrite paths/wires (dendrites) 113 such as dendrites 126 and 128. Neurons 111 are also connected to the crossbar 112 via axon paths/wires (axons) 115 such as axons 134 and 136.

Neurons 114 and 116 are dendritic neurons and neurons 118 and 120 are axonal neurons connected with axons 113. Specifically, neurons 114 and 116 are shown with outputs 122 and 124 connected to dendrites (e.g., bitlines) 126 and 128, respectively. Axonal neurons 118 and 120 are shown with outputs 130 and 132 connected to axons (e.g., wordlines or access lines) 134 and 136, respectively.

When any of the neurons 114, 116, 118 and 120 fire, they will send a pulse out to their axonal and to their dendritic connections. Each synapse provides contact between an axon of a neuron and a dendrite on another neuron and with respect to the synapse, the two neurons are respectively called pre-synaptic and post-synaptic.

Each connection between dendrites 126, 128 and axons 134, 136 are made through a digital synapse device 131 (synapse). Element 131 can be substituted with the TR-RNN architecture. The junctions where the synapse devices are located can be referred to herein as “cross-point junctions.” In general, in accordance with an embodiment of the invention, neurons 114 and 116 will “fire” (transmit a pulse) in response to the inputs they receive from axonal input connections (not shown) exceeding a threshold.

Neurons 118 and 120 will “fire” (transmit a pulse) in response to the inputs they receive from external input connections (not shown), usually from other neurons, exceeding a threshold. In one embodiment, when neurons 114 and 116 fire, they maintain a postsynaptic spike-timing-dependent plasticity (STDP) (post-STDP) variable that decays. For example, in one embodiment, the decay period can be 50 μs (which is 1000×shorter than that of actual biological systems, corresponding to 1000× higher operation speed). The post-STDP variable is employed to achieve STDP by encoding the time since the last firing of the associated neuron. Such STDP is used to control long-term potentiation or “potentiation,” which in this context is defined as increasing synaptic conductance. When neurons 118, 120 fire they maintain a pre-STDP (presynaptic-STDP) variable that decays in a similar fashion as that of neurons 114 and 116.

An external two-way communication environment can supply sensory inputs and consume motor outputs. Digital neurons 111 implemented using complementary metal oxide semiconductor (CMOS) logic gates receive spike inputs and integrate them. In one embodiment, the neurons 111 include comparator circuits that generate spikes when the integrated input exceeds a threshold. In one embodiment, synapses are implemented using flash memory cells, wherein each neuron 111 can be an excitatory or inhibitory neuron (or both). Each learning rule on each neuron axon and dendrite are reconfigurable as described below. This assumes a transposable access to the crossbar memory array. Neurons that spike are selected one at a time sending spike events to corresponding axons, where axons could reside on the core or somewhere else in a larger system with many cores.

The term electronic neuron as used herein represents an architecture configured to simulate a biological neuron. An electronic neuron creates connections between processing elements that are roughly functionally equivalent to neurons of a biological brain. As such, a neuromorphic and synaptronic system including electronic neurons according to embodiments of the invention can include various electronic circuits that are modeled on biological neurons, though they can operate on a faster time scale (e.g., 1000×) than their biological counterparts in many useful embodiments. Further, a neuromorphic and synaptronic system including electronic neurons according to embodiments of the invention can include various processing elements (including computer simulations) that are modeled on biological neurons. Although certain illustrative embodiments of the invention are described herein using electronic neurons including electronic circuits, the present invention is not limited to electronic circuits. A neuromorphic and synaptronic system according to embodiments of the invention can be implemented as a neuromorphic and synaptronic architecture including circuitry, and additionally as a computer simulation.

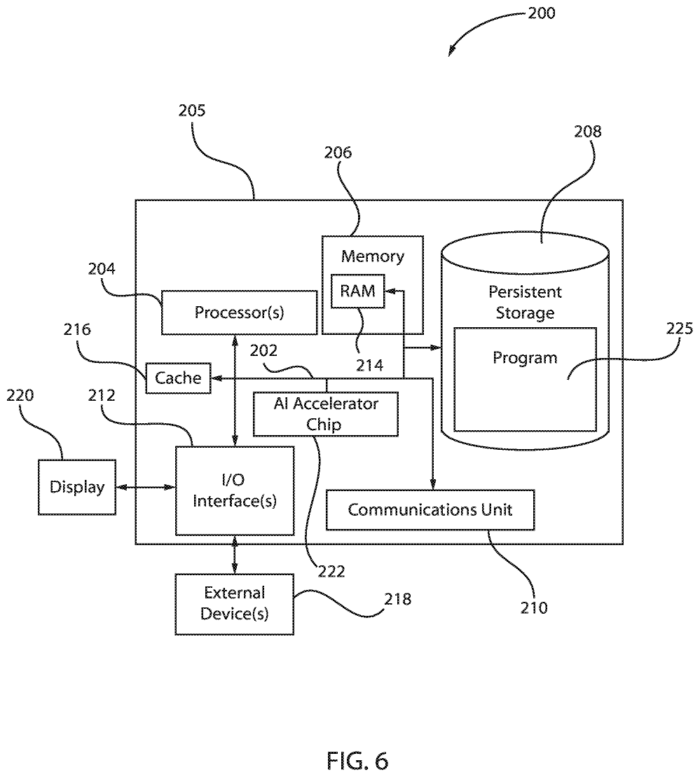

FIG. 6 is a block/flow diagram of an exemplary processing system employing the TR-RNN via an artificial intelligence (AI) accelerator chip, in accordance with an embodiment of the present invention.

FIG. 6 depicts a block diagram of components of system 200, which includes computing device 205. It should be appreciated that FIG. 6 provides only an illustration of one implementation and does not imply any limitations with regard to the environments in which different embodiments can be implemented. Many modifications to the depicted environment can be made.

Computing device 205 includes communications fabric 202, which provides communications between computer processor(s) 204, memory 206, persistent storage 208, communications unit 210, and input/output (I/O) interface(s) 212. Communications fabric 202 can be implemented with any architecture designed for passing data and/or control information between processors (such as microprocessors, communications and network processors, etc.), system memory, peripheral devices, and any other hardware components within a system. For example, communications fabric 202 can be implemented with one or more buses.

Memory 206, cache memory 216, and persistent storage 208 are computer readable storage media. In this embodiment, memory 206 includes random access memory (RAM) 214. In another embodiment, the memory 206 can be flash memory. In general, memory 206 can include any suitable volatile or non-volatile computer readable storage media.

In some embodiments of the present invention, deep learning program 225 is included and operated by AI accelerator chip 222 as a component of computing device 205. In other embodiments, deep learning program 225 is stored in persistent storage 208 for execution by AI accelerator chip 222 in conjunction with one or more of the respective computer processors 204 via one or more memories of memory 206. In this embodiment, persistent storage 208 includes a magnetic hard disk drive. Alternatively, or in addition to a magnetic hard disk drive, persistent storage 208 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 208 can also be removable. For example, a removable hard drive can be used for persistent storage 208. Other examples include optical and magnetic disks, thumb drives, and smart cards that are inserted into a drive for transfer onto another computer readable storage medium that is also part of persistent storage 208.

Communications unit 210, in these examples, provides for communications with other data processing systems or devices, including resources of distributed data processing environment. In these examples, communications unit 210 includes one or more network interface cards. Communications unit 210 can provide communications through the use of either or both physical and wireless communications links. Deep learning program 225 can be downloaded to persistent storage 208 through communications unit 210.

I/O interface(s) 212 allows for input and output of data with other devices that can be connected to computing system 200. For example, I/O interface 212 can provide a connection to external devices 218 such as a keyboard, keypad, a touch screen, and/or some other suitable input device. External devices 218 can also include portable computer readable storage media such as, for example, thumb drives, portable optical or magnetic disks, and memory cards.

Display 220 provides a mechanism to display data to a user and can be, for example, a computer monitor.

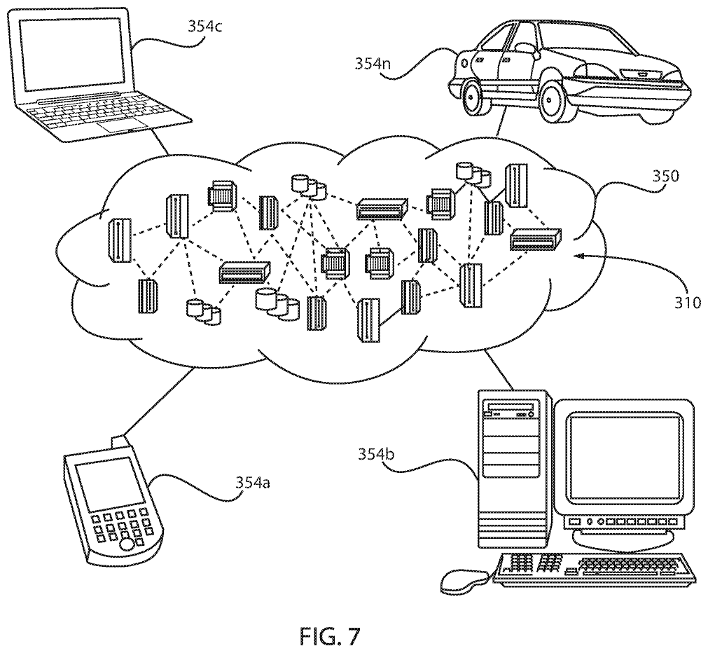

FIG. 7 is a block/flow diagram of an exemplary cloud computing environment, in accordance with an embodiment of the present invention.

It is to be understood that although this invention includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 7, illustrative cloud computing environment 350 is depicted for enabling use cases of the present invention. As shown, cloud computing environment 350 includes one or more cloud computing nodes 310 with which local computing devices used by cloud consumers, such as, for example, personal digital assistant (PDA) or cellular telephone 354A, desktop computer 354B, laptop computer 354C, and/or automobile computer system 354N can communicate. Nodes 310 can communicate with one another. They can be grouped (not shown) physically or virtually, in one or more networks, such as Private, Community, Public, or Hybrid clouds as described hereinabove, or a combination thereof. This allows cloud computing environment 350 to offer infrastructure, platforms and/or software as services for which a cloud consumer does not need to maintain resources on a local computing device. It is understood that the types of computing devices 354A-N shown in FIG. 7 are intended to be illustrative only and that computing nodes 310 and cloud computing environment 350 can communicate with any type of computerized device over any type of network and/or network addressable connection (e.g., using a web browser).

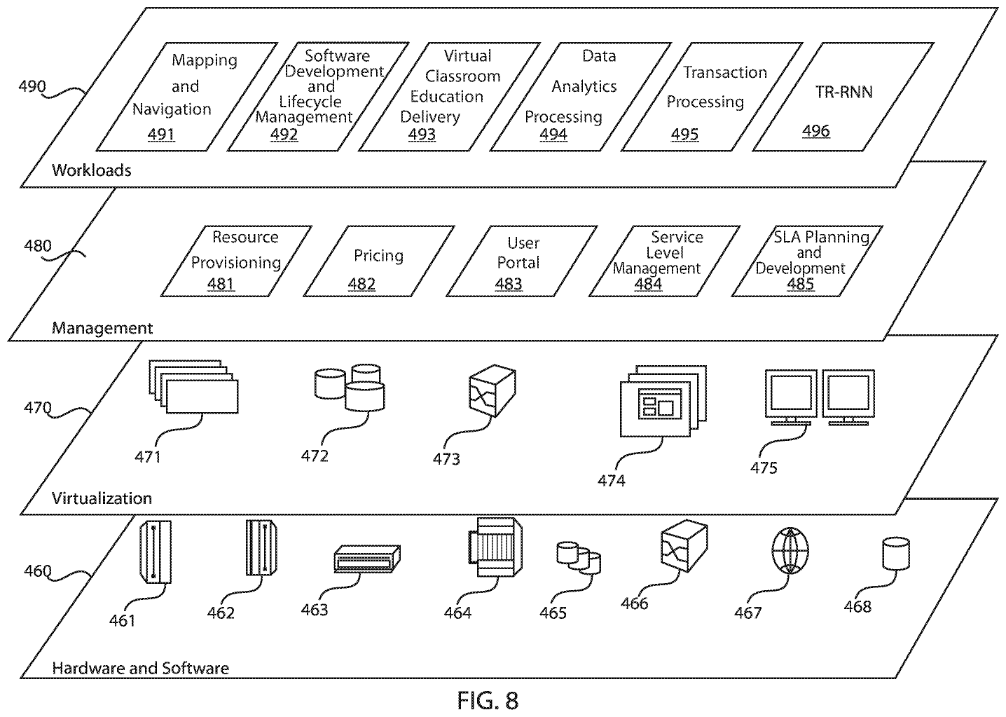

FIG. 8 is a schematic diagram of exemplary abstraction model layers, in accordance with an embodiment of the present invention. It should be understood in advance that the components, layers, and functions shown in FIG. 8 are intended to be illustrative only and embodiments of the invention are not limited thereto. As depicted, the following layers and corresponding functions are provided:

Hardware and software layer 460 includes hardware and software components. Examples of hardware components include: mainframes 461; RISC (Reduced Instruction Set Computer) architecture based servers 462; servers 463; blade servers 464; storage devices 465; and networks and networking components 466. In some embodiments, software components include network application server software 467 and database software 468.

Virtualization layer 470 provides an abstraction layer from which the following examples of virtual entities can be provided: virtual servers 471; virtual storage 472; virtual networks 473, including virtual private networks; virtual applications and operating systems 474; and virtual clients 475.

In one example, management layer 480 can provide the functions described below. Resource provisioning 481 provides dynamic procurement of computing resources and other resources that are utilized to perform tasks within the cloud computing environment. Metering and Pricing 482 provide cost tracking as resources are utilized within the cloud computing environment, and billing or invoicing for consumption of these resources. In one example, these resources can include application software licenses. Security provides identity verification for cloud consumers and tasks, as well as protection for data and other resources. User portal 483 provides access to the cloud computing environment for consumers and system administrators. Service level management 484 provides cloud computing resource allocation and management such that required service levels are met. Service Level Agreement (SLA) planning and fulfillment 485 provide pre-arrangement for, and procurement of, cloud computing resources for which a future requirement is anticipated in accordance with an SLA.

Workloads layer 490 provides examples of functionality for which the cloud computing environment can be utilized. Examples of workloads and functions which can be provided from this layer include: mapping and navigation 441; software development and lifecycle management 492; virtual classroom education delivery 493; data analytics processing 494; transaction processing 495; and TR-RNN 496.

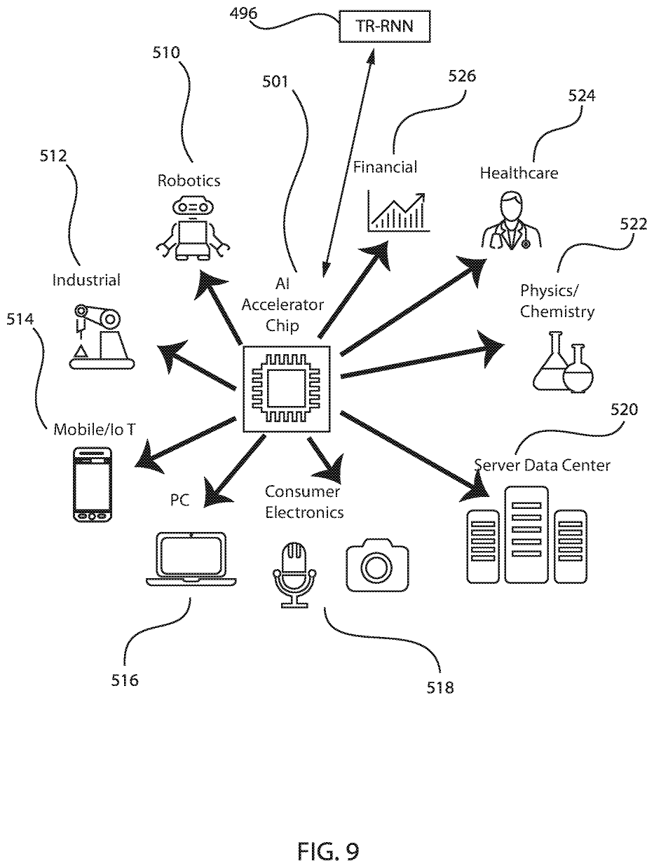

FIG. 9 illustrates practical applications for employing the TR-RNN via an AI accelerator chip, in accordance with an embodiment of the present invention.

The artificial intelligence (AI) accelerator chip 501 can implement the TR-RNN 496, and can be used in a wide variety of practical applications, including, but not limited to, robotics 510, industrial applications 512, mobile or Internet-of-Things (IoT) 514, personal computing 516, consumer electronics 518, server data centers 520, physics and chemistry applications 522, healthcare applications 524, and financial applications 526.

For example, Robotic Process Automation or RPA 510 enables organizations to automate tasks, streamline processes, increase employee productivity, and ultimately deliver satisfying customer experiences. Through the use of RPA 510, a robot can perform high volume repetitive tasks, freeing the company's resources to work on higher value activities. An RPA Robot 510 emulates a person executing manual repetitive tasks, making decisions based on a defined set of rules, and integrating with existing applications. All of this while maintaining compliance, reducing errors, and improving customer experience and employee engagement.

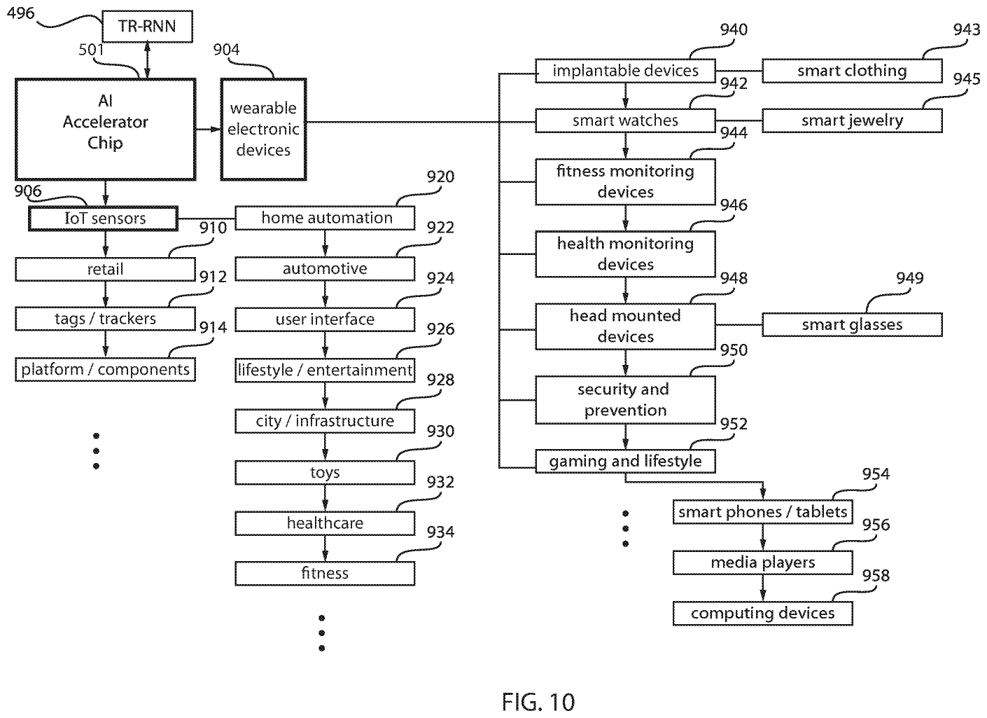

FIG. 10 is a block/flow diagram of a method for employing the TR-RNN with Internet of Things (IoT) systems/devices/infrastructure, in accordance with an embodiment of the present invention.

According to some embodiments of the invention, a network is implemented using an IoT methodology. For example, AI accelerator chip 501 can be incorporated implementing the TR-RNN 496, e.g., into wearable, implantable, or ingestible electronic devices and Internet of Things (IoT) sensors. The wearable, implantable, or ingestible devices can include at least health and wellness monitoring devices, as well as fitness devices. The wearable, implantable, or ingestible devices can further include at least implantable devices, smart watches, head-mounted devices, security and prevention devices, and gaming and lifestyle devices. The IoT sensors can be incorporated into at least home automation applications, automotive applications, user interface applications, lifestyle and/or entertainment applications, city and/or infrastructure applications, toys, healthcare, fitness, retail tags and/or trackers, platforms and components, etc. The AI accelerator chip 501 described herein can be incorporated into any type of electronic devices for any type of use or application or operation.

IoT systems allow users to achieve deeper automation, analysis, and integration within a system. IoT improves the reach of these areas and their accuracy. IoT utilizes existing and emerging technology for sensing, networking, and robotics. Features of IoT include artificial intelligence, connectivity, sensors, active engagement, and small device use. In various embodiments, the AI accelerator chip 501 of the present invention can be incorporated into a variety of different devices and/or systems. For example, the AI accelerator chip 501 can be incorporated into wearable or portable electronic devices 904. Wearable/portable electronic devices 904 can include implantable devices 940, such as smart clothing 943. Wearable/portable devices 904 can include smart watches 942, as well as smart jewelry 945. Wearable/portable devices 904 can further include fitness monitoring devices 944, health and wellness monitoring devices 946, head-mounted devices 948 (e.g., smart glasses 949), security and prevention systems 950, gaming and lifestyle devices 952, smart phones/tablets 954, media players 956, and/or computers/computing devices 958.

The AI accelerator chip 501 of the present invention can be further incorporated into Internet of Thing (IoT) sensors 906 for various applications, such as home automation 920, automotive 922, user interface 924, lifestyle and/or entertainment 926, city and/or infrastructure 928, retail 910, tags and/or trackers 912, platform and components 914, toys 930, and/or healthcare 932, as well as fitness 934. The IoT sensors 906 can employ the AI accelerator chip 501. Of course, one skilled in the art can contemplate incorporating such AI accelerator chip 501 into any type of electronic devices for any types of applications, not limited to the ones described herein.

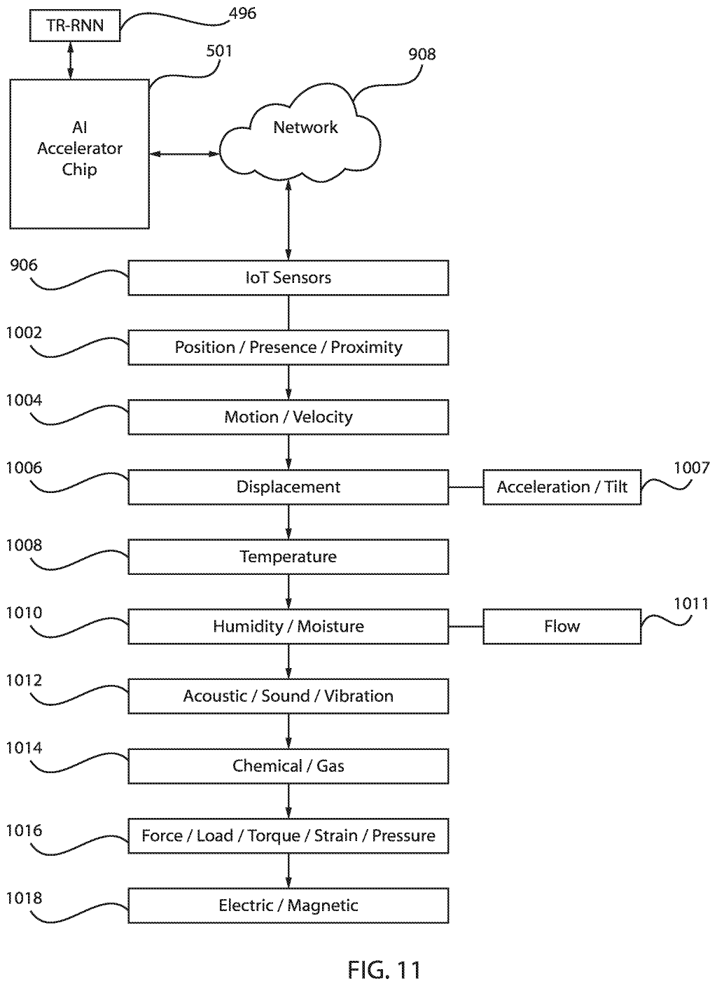

FIG. 11 is a block/flow diagram of exemplary IoT sensors used to collect data/information related to the TR-RNN operations, in accordance with an embodiment of the present invention.

IoT loses its distinction without sensors. IoT sensors act as defining instruments which transform IoT from a standard passive network of devices into an active system capable of real-world integration.

The IoT sensors 906 can employ the AI accelerator chip 501 implementing the TR-RNN 496 to transmit information or data, continuously and in in real-time, via a network 908, to any type of distributed system. Exemplary IoT sensors 906 can include, but are not limited to, position/presence/proximity sensors 1002, motion/velocity sensors 1004, displacement sensors 1006, such as acceleration/tilt sensors 1007, temperature sensors 1008, humidity/moisture sensors 1010, as well as flow sensors 1011, acoustic/sound/vibration sensors 1012, chemical/gas sensors 1014, force/load/torque/strain/pressure sensors 1016, and/or electric/magnetic sensors 1018. One skilled in the art can contemplate using any combination of such sensors to collect data/information of the distributed system for further processing. One skilled in the art can contemplate using other types of IoT sensors, such as, but not limited to, magnetometers, gyroscopes, image sensors, light sensors, radio frequency identification (RFID) sensors, and/or micro flow sensors. IoT sensors can also include energy modules, power management modules, RF modules, and sensing modules. RF modules manage communications through their signal processing, WiFi, ZigBee®, Bluetooth®, radio transceiver, duplexer, etc.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory, a read-only memory, an erasable programmable read-only memory (EPROM or Flash memory), a static random access memory, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to at least one processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks or modules.

The computer readable program instructions can also be loaded onto a computer, other programmable data processing apparatus, or other device to cause a series of operational blocks/steps to be performed on the computer, other programmable apparatus or other device to produce a computer implemented process, such that the instructions which execute on the computer, other programmable apparatus, or other device implement the functions/acts specified in the flowchart and/or block diagram block or blocks or modules.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which includes one or more executable instructions for implementing the specified logical function(s). In some alternative implementations, the functions noted in the blocks can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as readily apparent by one of ordinary skill in this and related arts, for as many items listed.

Having described preferred embodiments of a method for reconstructing time series data including irregular time intervals and missing values to predict future data from the time series data using an RNN (which are intended to be illustrative and not limiting), it is noted that modifications and variations can be made by persons skilled in the art in light of the above teachings. It is therefore to be understood that changes may be made in the particular embodiments described which are within the scope of the invention as outlined by the appended claims. Having thus described aspects of the invention, with the details and particularity required by the patent laws, what is claimed and desired protected by Letters Patent is set forth in the appended claims.

1. A computer-implemented method for reconstructing time series data including irregular time intervals and missing values to predict future data via a time-aligned reconstruction recurrent neural network (TR-RNN) architecture, the method comprising:
obtaining irregular time series data X={x₁, . . . , xₜ, . . . , x_{T}} and time interval data Δ={δ₁, . . . , δₜ, . . . , δ_{T}}, where xₜ is a D-dimensional feature vector, T is a total number of observations, δₜ is a D-dimensional time interval vector, and a d-th element δₜ^{d} of δₜ represents a time interval from a last observation;
replacing missing values in xₜ with imputed values using an imputation to obtain \tilde{x}ₜ;
rescaling data of the time interval δₜ to obtain rescaled time interval data φ(δₜ) by calculating φ(δₜ)= [symbol] _{φ} log (e+ max(0, [symbol] _{ϕ}δₜ+b_{ϕ}))+b_{φ}, where W_{φ}, W_{ϕ}, b_{ϕ}, b_{φ} are network parameters of a neural network and e is Napier's constant; and
multiplying \tilde{x}ₜ by φ(δₜ) to obtain \hat{x}ₜ as regular time series data for input to the TR-RNN architecture.

2. The computer-implemented method of claim 1, wherein the TR-RNN architecture is applied to long short-term memory (LSTM).

3. The computer-implemented method of claim 1, wherein the TR-RNN architecture is applied to gated recurrent units (GRU).

4. The computer-implemented method of claim 1, wherein the imputed values are derived from a weighted mean with an empirical mean.

5. The computer-implemented method of claim 1, wherein a current hidden state in a recurrent layer is given as hₜ=RNNCell(\hat{X}ₜ, hₜ₋₁), where hₜ₋₁, hₜ are previous and current hidden states, and W∈ [symbol] ^{HxD}, U∈ [symbol] ^{HxH}, and b∈ [symbol] ^{H} are network parameters, where H is a number of units of hidden nodes.

6. A computer program product for reconstructing time series data including irregular time intervals and missing values to predict future data via a time-aligned reconstruction recurrent neural network (TR-RNN) architecture, the computer program product comprising a computer readable storage medium having program instructions embodied therewith, the program instructions executable by a computer to cause the computer to:
obtain irregular time series data X={x₁, . . . , xₜ, . . . , x_{T}} and time interval data Δ={δ₁, . . . , δₜ, . . . , δ_{T}}, where xₜ is a D-dimensional feature vector, T is a total number of observations, δₜ is a D-dimensional time interval vector, and a d-th element δₜ^{d} of δₜ represents a time interval from a last observation;
replace missing values in xₜ with imputed values using an imputation to obtain \tilde{x}ₜ;
rescale data of the time interval δₜ to obtain rescaled time interval data φ(δₜ) by calculating φ(δₜ)= [symbol] _{φ} log (e+ max(0, [symbol] _{ϕ}δₜ+b_{ϕ}))+b_{φ}, where W_{φ}, W_{ϕ}, b_{ϕ}, b_{φ} are network parameters of a neural network and e is Napier's constant; and
multiply \tilde{x}ₜ by φ(δₜ) to obtain \hat{x}ₜ as regular time series data for input to the TR-RNN architecture.

7. The computer program product of claim 6, wherein the TR-RNN architecture is applied to long short-term memory (LSTM).

8. The computer program product of claim 6, wherein the TR-RNN architecture is applied to gated recurrent units (GRU).

9. The computer program product of claim 6, wherein the regular time series data for input to the TR-RNN architecture includes healthcare data.

10. The computer program product of claim 6, wherein the imputed values are derived from a weighted mean with an empirical mean.

11. The computer program product of claim 6, wherein a current hidden state in a recurrent layer is given as hₜ=RNNCell(\hat{x}ₜ,hₜ₋₁), where hₜ₋₁, hₜ are previous and current hidden states, and W∈ [symbol] ^{HxD}, U∈ [symbol] ^{HxH}, and c∈ [symbol] ^{H} are network parameters, where H is a number of units of hidden nodes.

12. A computer-implemented method for reconstructing time series data including irregular time intervals and missing values to predict future data via a time-aligned reconstruction recurrent neural network (TR-RNN) architecture, the method comprising:
performing imputation by using a weighted mean of a value of a last observation and an empirical mean;
transforming, via time-aligned reconstruction, inputs to time-aligned representations incorporating time intervals to handle the irregular time intervals as regular time intervals; and
employing a recurrent layer.

13. The computer-implemented method of claim 12, wherein the TR-RNN architecture is applied to long short-term memory (LSTM).

14. The computer-implemented method of claim 12, wherein the TR-RNN architecture is applied to gated recurrent units (GRU).

15. The computer-implemented method of claim 12, wherein the regular time series data for input to the TR-RNN architecture includes healthcare data.

16. The computer-implemented method of claim 12, wherein, in the time-aligned reconstruction, a time interval of each input is rescaled.

17. The computer-implemented method of claim 16, wherein the rescaling is performed with scale parameters and a log transformation.

18. The computer-implemented method of claim 17, wherein the rescaled time intervals are multiplied to inputs xₜ, where xₜ is a D-dimensional feature vector.

19. The computer-implemented method of claim 12, wherein the time-aligned reconstruction is given as φ(δₜ)= [symbol] _{φ} log (e+ max(0, [symbol] _{ϕ}δₜ+b_{ϕ}))+b_{φ}, where W_{φ}, W_{ϕ}, b_{ϕ}, b_{φ} are network parameters of a neural network and e is Napier's constant.

20. The computer-implemented method of claim 12, wherein a current hidden state in the recurrent layer is given as hₜ=RNNCell(\hat{x}ₜ,hₜ₋₁), where hₜ₋₁, hₜ are previous and current hidden states, and WE [symbol] ^{HxD}, U∈ [symbol] ^{HxH}, b∈ [symbol] ^{H} are network parameters, where H is a number of units of hidden nodes.
